(19) United States
(12) Patent Application Publication
(10) Pub. No.: US 2009/0090305 A1
(43) Pub. Date: Apr. 9, 2009

(54) System for humans and pets to interact remotely

(75) Inventors: Adrian David Cheok, Singapore (SG); Keng Soon Teh, Singapore (SG)

Correspondence Address: Adrian David Cheok, IDM Institute, National University of Singapore, 21 Lower Kent Ridge Road,, Singapore, 119077, omitted

(73) Assignee: NATIONAL UNIVERSITY OF SINGAPORE, Singapore (SG)

(21) Appl. No.: 11/866,416

(22) Filed: Oct. 3, 2007

(51) Int. Cl. A01K 29/00

(52) U.S. Cl. 119/707; 340/573.3

(57) ABSTRACT

A system that allows humans to interact with and send touch remotely to their pets. The system has a tangible interface for humans that allow both visual and tactile modes of communication on one end, and a haptic pet wearable jacket on the other end. It allows humans to interact remotely with pets even when they are not physically at the same place as the pets. On the tangible interface for humans, human views the real time movement of the pet in the form of a pet doll sitting on a mechanical positioning system. The movement of the actual pet is tracked using a web camera. The pet doll has embedded touch sensing circuit that senses and transmit data wirelessly to the computer. This touch data is sent across the Internet to another computer which is connected to the haptic pet wearable jacket. The real pet wears the pet jacket, which is able to reproduce the touching sensation via vibrating motors. The pet owner can tangibly touch the pet doll, sending touch signals to the pet in a remote location. Also, the pet owner receives a visual feedback from the movement of the pet via the pet doll interface.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to a system for humans to interact with their pets remotely, specifically a novel method and system for humans to interact with their pets over the Internet.

2. Prior Art

In the real world, touch and physical manipulation play a key role in understanding and affecting our environment. Touch is a key advantage for human being to interact, understand, and feel affected by the real environment. The use of the Internet as a medium for transferring human touch could be the next innovative application in interaction technology, as it provides haptic sensation of touch for remote users.

Very little research has, until now, been done in the field of human-computer pet interaction. Most of the work in this field is in robot pets. For instance, Sony introduced a reconfigurable robot called AIBO based on OPENR, a standard for robot entertainment systems with 4 legs and a head, where each leg had 3 degree of freedom which can be reconfigured to a wheel based mobile robot. The AIBO entertainment robot dog can be programmed using OPENR. AIBO had built-in artificial intelligence and had been used in many applications such as robot-assisted therapy in Japan. To some scientists, robots are the answer to caring for aging societies in Japan and other nations where the young are destined to be overwhelmed by an increasingly elderly population. These advocates see robots serving not just as helpers (e.g. carrying out simple chores and reminding patients to take their medication) but also as companions, even if the machines can carry on only a semblance of a real dialogue.

Then there was the Tamagotchi, a once very popular virtual pet. It was marketed as ‘the original virtual reality pet’. It can be described briefly as a tiny hand-held LCD video game that comes attached to a key chain or bracelet. The objective of the game is to simulate the proper care and maintenance of a ‘virtual chicken’, which is accomplished through performing the digital analogy of certain ‘parental’ responsibilities, including feeding, playing games, scolding, medicating, and cleaning up after it. If it is taken good care of, it will slowly grow bigger, healthier, and more beautiful every day. But if it is neglected, the little creature may grow up to be mean or ugly. Druin also proposed a robot animal that tells stories for children. Sekiguchi presented a teddy bear robot as a robot user interface (RUI) for interpersonal communication. All the above related works use non-real animals, and instead they used robot or virtual pets. It is easier to make such systems which interact with virtual pets, rather the real animals. However, as will be shown in the next section below, there are definite differences and advantages in using interactive research technology with real living animals, rather than robotic or virtual animals.

The growing importance of human-to-pet communication can also be seen in recent related company products. Recently, an entertainment toy company has produced a Bowlingual dog language translator device. It displays some words on its LCD panel when the dog barks. As an another example, cellular giant NTT DoCoMo Inc launched pet-tracking location based services for I-mode subscribers in Japan, connecting pets wirelessly to their owners. This is a one way position information interface (non interactive). However to our knowledge, our system is the first system to allow real time remote interaction with free moving live pets in a tangible manner. In addition, the invention allows both pets and pet owners to experience real time tangible interaction.

We have looked at several related human-robotic-virtual pet interactions in the previous sub-section. However there are some disadvantages in such robotic virtual pet systems, and lacking features in the interaction with humans, which have been found in research studies. Behrens criticizes the fact that Tamagotchis never die (in fact they do, but they are born again and again as long as batteries are fresh), unlike a real pet. Therefore, people, especially children, can become confused about the reality of the relationship. Children will no longer treasure the companionship with their pets because even if the pet “dies”, it can be brought back to life by changing the battery. The lack of such moral responsibility will cultivate a negative psychology which eventually will do harm to the society. After few times children will lose their interest in such a repetitive game, however a real pet will show new and different behaviours everyday based on its owner's actions. This makes the real pet more engaging in the long term than a virtual, or robotic, pet. Another related psychological study was done using Furby (a realistic, interactive “animatronic” plush pet that interacts with the environment through sight, touch, hearing, and physical orientation). Turkle and Audley studied a group of young children who owned a Furby. It was found that when the robotic animal broke, the children felt betrayed, taken in and fooled. It had revealed its nature as a machine and they felt embarrassed and angry. They were totally unwilling to invest that kind of emotional relationship in an object again. This showed there is a fundamental difference in perception even in young children, when they know they are dealing with non-biological living pet companions.

Studies also found that robotic dogs such as AIBO could provide the elderly with some of the physiological, cognitive and emotional benefits. However it was shown that although there is a kind of psychology of connection, it was not the same as real companionship that grows between human and real pet animals. Hence it can be seen that if the interaction between the human and animal is replaced with an equivalent system with a human and virtual or robotic animal, there are definite disadvantages and differences in the emotional response and feeling of companionship. It is thus proposed that it is critical to develop a remote interactive system between humans and biological living animals to promote the human response of true companionship with the animal. Furthermore, this system is equally aimed at promoting positive feelings of enjoyment in pet owners as well as in pets, which cannot be done if only virtual/robot animals are used.

U.S. Pat. No. 6,885,305, issued Apr. 26, 2005, to Davis describes a system for sending messages to pets using a hand-held remote transmitter and a receiver attached to the pet. The system is used to locate pets in the event that they wander out of sight from their pet owners. The system does not attempt to induce a pleasurable feeling in pets.

U.S. Pat. No. 6,675,743 B1, issued Jan. 13, 2004, to Jeffrey et al., describes a vibrator blanket for massaging pets. The blanket is activated by a switch used to select different levels of vibration. However, this switch is activated manually by pet owners, which does not allow for remote interaction between pet owners and pets.

U.S. Pat. No. 6,650,243 B2, issued Nov. 18, 2003, to Aull, describes a pet affection indicator device which gives pet owner information regarding the quantity of affection a pet owner is giving to the pet. However, this system does not allow for pet owner to remotely communicate with pet. It has a one way communication from pet to pet owner, which differs from our invention.

U.S. Pat. No. 5,872,516, issued Feb. 16, 1999, to Bonge, Jr., describes an ultrasonic transceiver and remote output devices controlled by the transceiver for use by domestic pets. The system is used as an electronic pet containment system, a remote pet trainer and a remotely operated, fully automatic pet door. However, the range of transmitting commands from pet owner to pet is still within a localized area in the range of the ultrasonic transceiver and receiver.

None of the above inventions and patents, taken either singularly or in combination, is seen to describe the instant invention as claimed. Thus a system for humans and pets to interact remotely by sensing, transmitting and reproducing touch is developed, solving the aforementioned problems.

### OBJECTS AND ADVANTAGES

Accordingly, several objects and advantages of the present invention are:
(a) To provide a pet doll embedded with touch sensors and circuit which allows pet owners to have a sense of touching their actual pets via this pet doll interface
(b) To provide a pet doll that tracks and replicates the movement of the pet via a camera tracking algorithm and custom build mechanical hardware system which allows pet owners to feel the presence of their pets in their vicinity, thus providing a sense of security to the pet owners with regards to the well being of the pet
(c) To provide a system that is inter-connected via the Internet which allows pet owners and pets to interact remotely over a large distance
(d) To provide a haptic pet jacket to be worn by the pet which allows pets to feel a sense of touch from the pet owners
(e) To promote pleasurable feeling in pets even while being separated from pet owners

Further objects and advantages of my invention will become apparent from a consideration of the drawings and ensuing description.

### SUMMARY OF CLAIMS

The present invention is a system that enables humans to interact with their pets remotely. The system comprises of two main components namely the Pet Side System and the Human Side System. The pet is at the Pet Side System end whereas the user is at the Human Side System end. The Human Side System is mobile and can be at any location in the world, as long as there is Internet connection. The user is presented with a pet doll that mimics the real pet's movements. This pet doll also senses the human users touch and recreates the touch with the use of vibrating actuators placed on the haptic jacket worn by the pet in the Pet Side System.

The Pet Side System contains a jacket worn by the pet, a computer and a camera. The camera connected to the computer captures the pet's movements and the processed tracking data of the pet is sent to the Human Side System via the Internet. The jacket worn by the pet contains vibrating motor actuators, the circuitry to drive these actuators and a battery pack. This circuitry in the haptic pet jacket maintains a Bluetooth link to the computer at the Pet Side System. The computer sends the information necessary for the vibrating actuators in the pet jacket to recreate the touching sensed at the Human Side System.

The Human Side System contains a computer, an XY mechanical positioning table and a pet doll. The pet doll contains capacitive touch sensors, the drive circuitry for the touch sensors and the batteries for their operation. This circuitry is connected to the computer on the Human Side System via a serial link. When the user touches the pet, the touch sensors sense touch and send these details via the Bluetooth link to the computer, which in turn is sent to the computer on the Pet Side System via the Internet. The XY mechanical positioning table contains circuitry and three stepper motors which are used to recreate the pets X, Y and orientation detail based on the information received on the pet tracking details. The pet tracking details received by the Human Side System computer via the Internet from the Pet Side System computer which is then sent to the circuitry associated with the XY mechanical positioning table via the serial link.

Accordingly, it is the principal object of the invention to facilitate a system where the users can interact with their pets remotely through tangible means such as touch.

Another object of the invention is to have two systems in which one contains the pet and the other has the human user and where both systems are connected via the Internet provided from the computers placed at both ends of the system.

It is another object of the invention to provide a haptic jacket which is worn by the pet as mentioned above which contains a vibrating actuator system to recreate the touch feeling, connected in a wireless manner via Bluetooth to the computer.

It is a further object of the invention to provide a camera tracking system connected to a computer which tracks the movement of the pet and sends the tracking details to the Human Side System with the user via the Internet.

Still another objective of the system is to have a pet doll embedded with touch sensors which senses the touch of the user which is sent to the computer via a Bluetooth link.

Yet another objective of the invention is to provide a XY mechanical table with three stepper motors, which is connected to the computer via a serial link to recreate the pet movements.

It is another objective of the system to provide algorithms for tracking and the operation of the microcontrollers in the circuitry in both systems.

These and other objectives of the present invention will become readily apparent upon further review of the following specification and drawings.

### DRAWINGS

### Figures

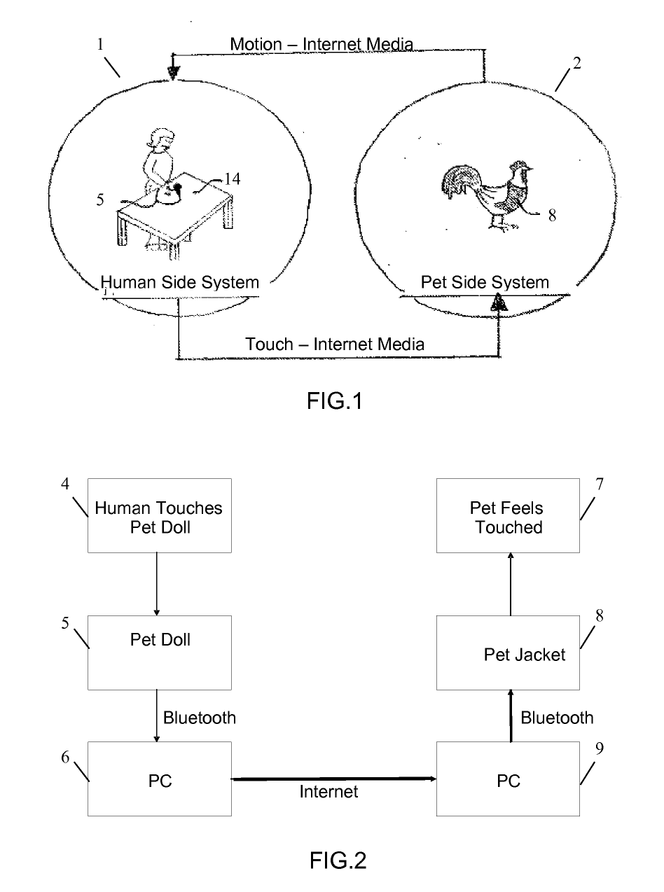

FIG. 1 shows a general schematic overview of a remote human pet interaction system.

FIG. 2 shows the process of remote touch being transferred from human to pet via two computers connected to the Internet

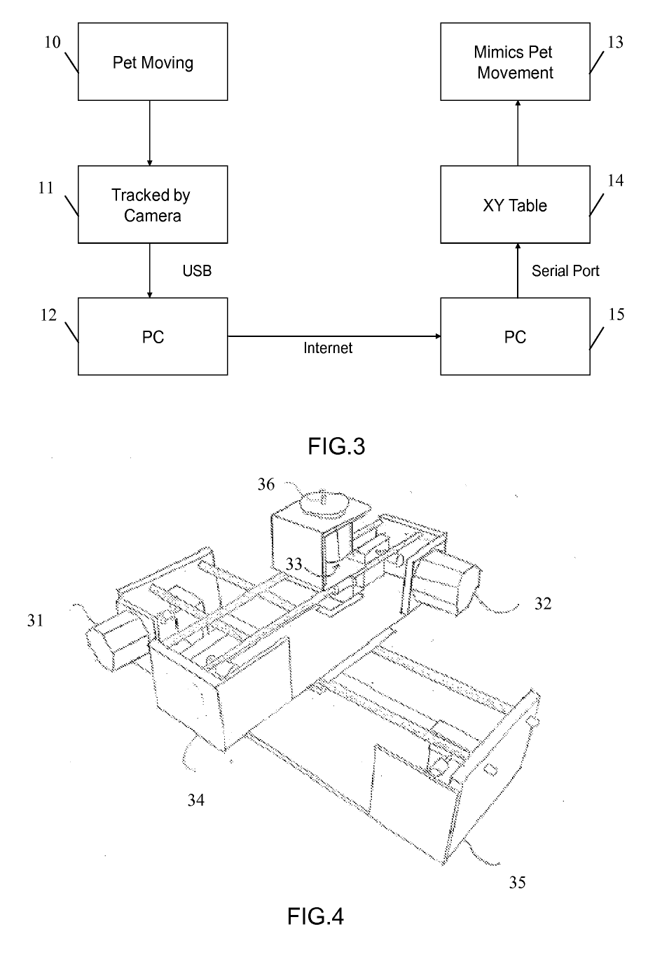

FIG. 3 shows the process of pet's movement being sent across the Internet and replicated by a pet doll in the vicinity of the pet owner

FIG. 4 shows a mechanical positioning table which moves the pet doll according to the movements of the pet in three dimensions, abscissas axis, ordinates axis and rotational axis.

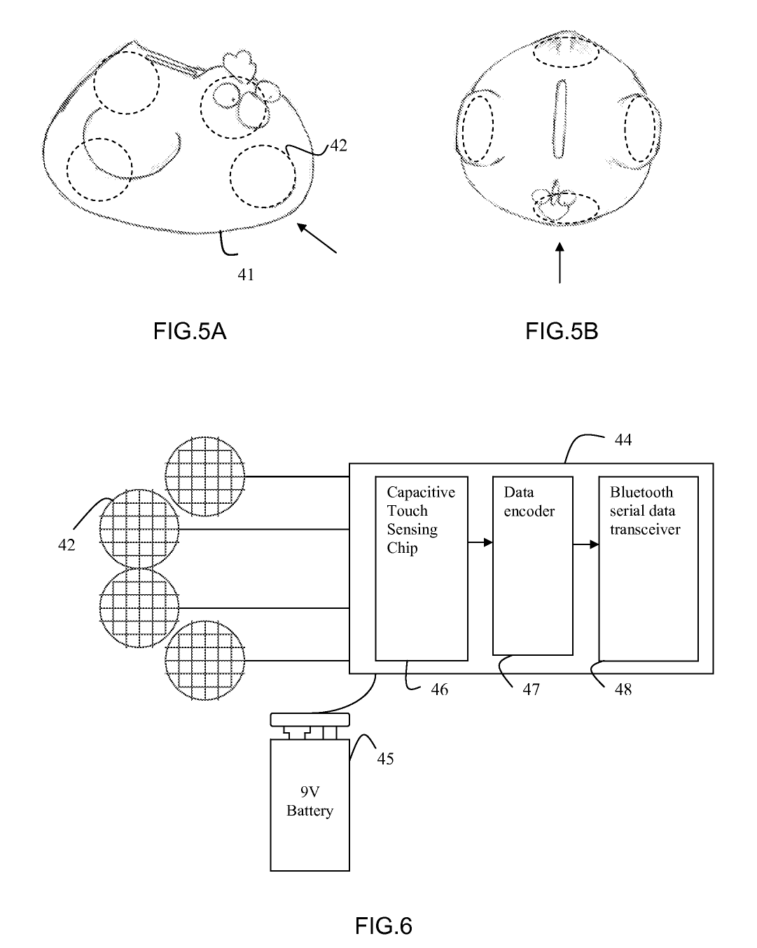

FIG. 5A and FIG. 5B shows different end views of a pet doll with embedded touch sensors and wireless data transmitter circuit.

FIG. 6 shows a block diagram of the touch sensing and wireless data transmitter circuit embedded in pet doll.

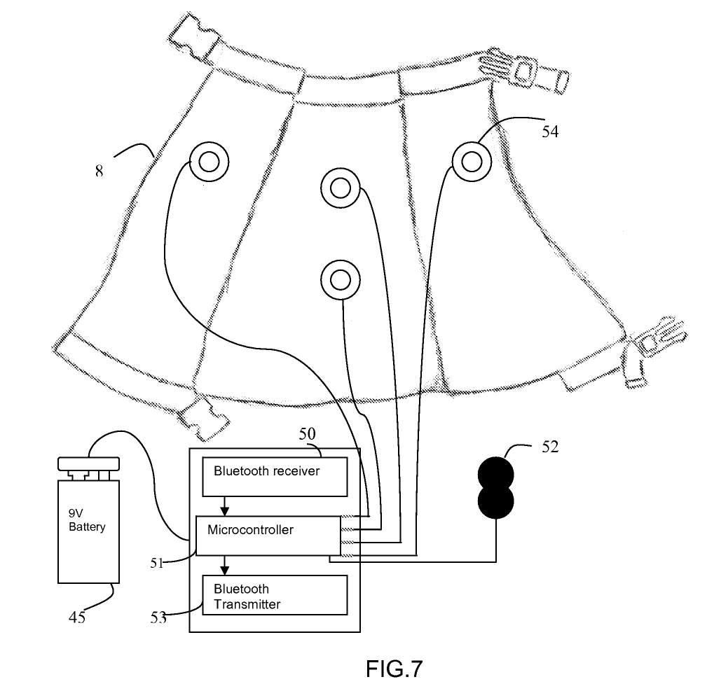

FIG. 7 shows a pet jacket embedded with touch actuators and circuit.

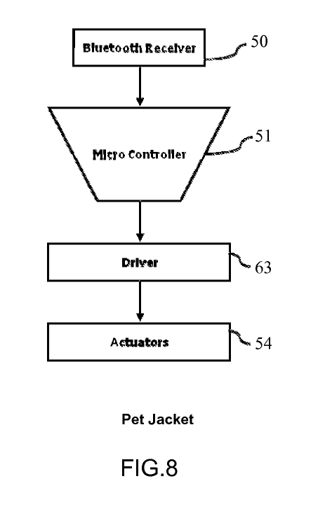

FIG. 8 shows a block diagram of the circuit embedded in the pet jacket.

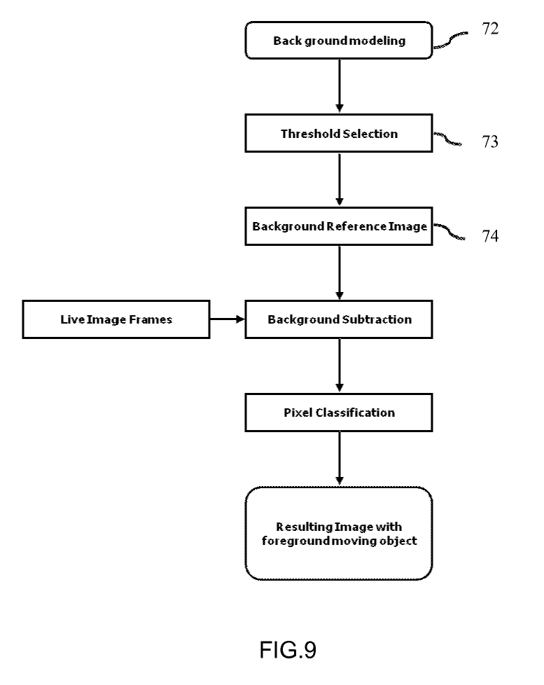

FIG. 9 shows a software program algorithm to detect and track a pet using a camera connected to a computer.

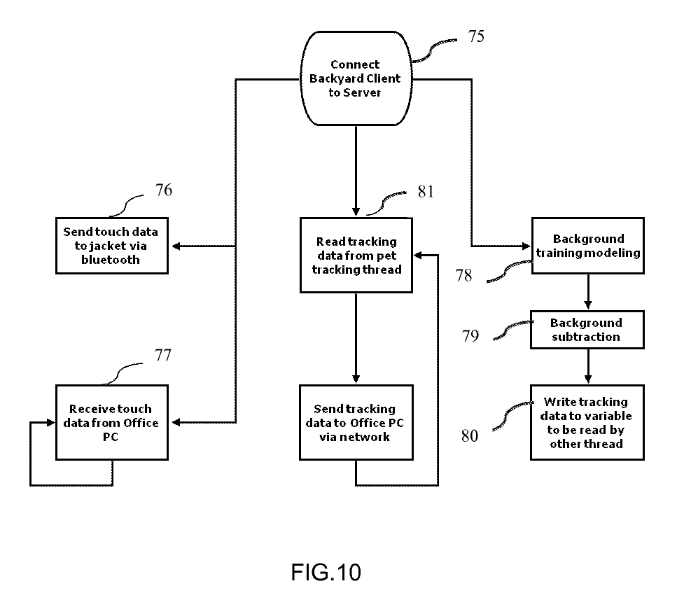

FIG. 10 shows a software program algorithm implemented on the Pet Side System computer.

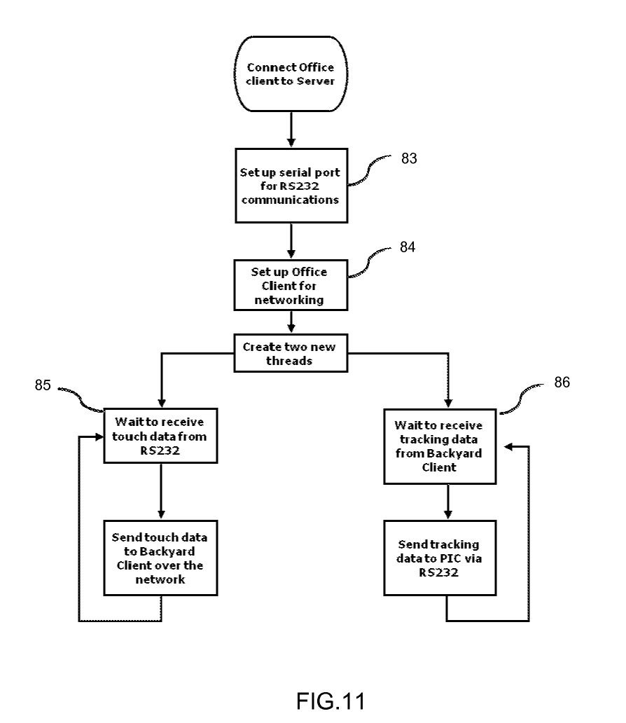

FIG. 11 shows a software program algorithm implemented on the Human Side System computer.

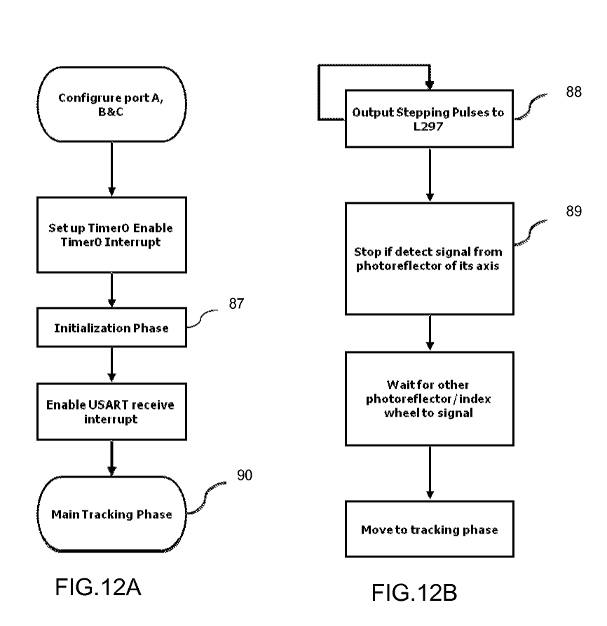

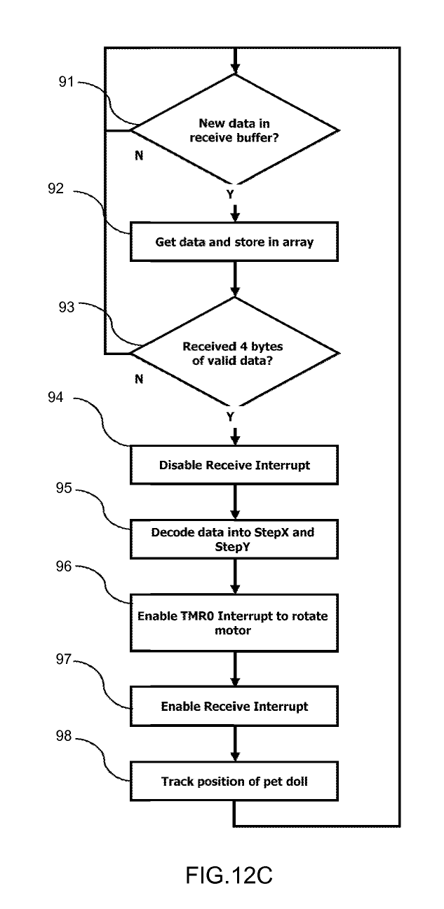

FIG. 12A shows an overview of firmware algorithm implemented on microcontrollers on the Human Side System, comprising of initialization phase and tracking phase.

FIG. 12B shows the detailed firmware algorithm in the initialization phase.

FIG. 12C shows the detailed firmware algorithm in the tracking phase.

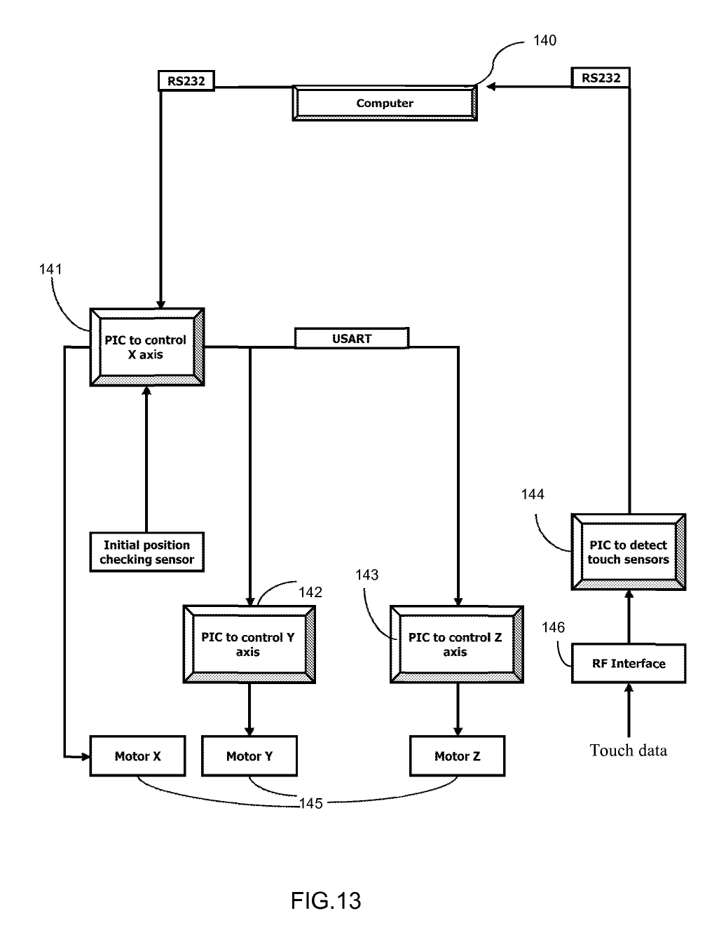

FIG. 13 shows the overall hardware architecture for the office system.

### DETAILED DESCRIPTION OF THE INVENTION

### (i) Static Description of Figures

Referring to the drawings, wherein like numerals refer to like elements throughout the several views, there is shown in FIG. 1 a schematic representation of the components of a system for humans and pets to interact in a tangible manner via the Internet.

The present invention is a system designed specifically to enable humans to send touch via the Internet to their pets. The input and output devices, including the intermediary protocol to transfer data are the subjects of this invention. The system is divided into two major components which we term the Human Side System 1 and the Pet Side System 2. On the Human Side System, pet owner interacts remotely with a pet through a pet doll interface with embedded touch sensing circuitry 5. This pet doll sits on an XY mechanical positioning table 14 which moves the pet doll according to the actual two dimensional movement of the pet. On the Pet Side System, pet is able to feel owner's attention by wearing a haptic pet jacket with embedded vibrating actuators 8. The movement of the pet is monitored and tracked by a web camera and computer running an object tracking algorithm. In order to cater for use with different kind of pets, the embodiment of the input touch sensing device and the output haptic jacket can be tailored to suit the target users.

FIG. 4 depicts the hardware system of the XY mechanical positioning table 3. In order to move the pet on the table, we designed and implemented an XY positioning system using two stepper motors 31,32 for movements in X and Y direction and also one stepper motor 33 for the rotation of the doll. These position data are calculated based on the real pet motion in the backyard 2 on the Pet Side System by a web camera and a computer vision tracking algorithm and then the tracking results which are X, Y and rotation information are sent through the Internet to the Human Side System 1. The XY table consists of X and Y axis structures 34,35, each driven by a stepper motor 31,32. A third stepper motor 33 is mounted on the carrier of the structure, with the axis of rotation perpendicular to the table. By attaching the doll to the top of Y structure 35 by magnets 36 on both the doll and the third motor 33, the doll follows the motor 2D movement as well as rotation, without direct coupling.

FIG. 5 above shows the hollow doll 41 which functions as the input device in our project. The doll 41 consists of a touch-sensing board which is placed inside the doll. A total of four capacitive sensors 42 are used for sensing human touch. All the capacitive sensors 42 are placed on the inside body of the doll 41, and are not visible to user. The capacitive sensors 42 detect the user's touch on different parts of the doll's body 41. The touch data (touch instance and touch location) will be transmitted over the internet to be recreated at the output pet jacket. The touch will be recreated by activating vibrators on a jacket which will worn by real pet. The pet will be able to feel the touch in the same place where the user touches the doll 41.

Referring to FIG. 7, a 9V battery 45 is used to power the circuit embedded in the haptic pet jacket 8. Four vibrating motors 54 are fitted on the jacket 8, each having a direct correspondence with a capacitive sensor 42. The touch data that is received over the Internet is sent from the receiving computer to the pet's jacket 49 via Bluetooth. The data is received on a Bluetooth transceiver 50. The received data is sent to a micro-controller 51 which actuates the respective motors 54 attached to the jacket 49 corresponding to the area of touch on the input doll 41. The microcontroller 51 stores the movement data of the chicken and transmits data to indicate the position of the chicken in the backyard. This enables the movement of the chicken in the Pet Side System to be recreated at the Human Side System, thus enabling the pet owner to visualize the current movement of the chicken in its backyard. The data is transmitted to the receiving computer via Bluetooth 50.

### (ii) Operational Description of Figures

Referring to FIG. 2, the interaction process is explained as follows. Human pet owner touches pet doll 4. On the pet doll 5, the touch sensing circuitry on the doll sends this data (touch event and touch position) to the human side computer 6 via Bluetooth. The computer sends data over the Internet to the computer 9 on the pet side. This data is transferred via Bluetooth to activate the corresponding vibrating actuators 54 on the jacket 8 that the pet is wearing so that the pet can feel the touch in the same spot that the user touched the doll.

Referring to FIG. 3, the tracking of pet movement is explained as follows. The movement of the pet 10 is tracked by a web camera 11 placed on the Pet Side System. The computer on the Pet Side System 12 to which the web camera is connected runs a pet tracking program. The algorithm of this program is described in FIG. 10. As a result, it sends the tracking data to the computer on the Human Side System 15 through the Internet. The computer on the Human Side System processes and converts the tracking data to the motor control data. The stepper motors then move the pet doll accordingly on the XY mechanical positioning table 14. This way, the user can see the motion of the pet reproduced on the XY table 14.

The diagram in FIG. 6 above shows the circuit and components that are embedded inside the hollow body of the pet doll 41. The components comprise of a touch sensing circuit 44, four capacitive touch sensors 42 and a 9V battery 45. The touch-sensing board 44 contains a capacitive touch sensing chip QT161 46 from Quantum Research Group, a data encoder 47 and a Bluetooth serial data transceiver 48. All four capacitive sensors 42 are interfaced to the QT161 sensor chip 46. The QT161 chip 46 is configured such that it will respond to a change in the capacitive field of the capacitive sensors 42 due to the disturbance caused by human touch. The touch data sensed by the QT161 sensor chip 46 is send to an encoder chip 47. The output from the encoder 47 is sent to the Bluetooth transceiver 48 which transmits this data to the Human Side System computer.

Referring to FIG. 8, the block diagram describes the pet jacket circuit component. The circuit has three main components comprising of a Bluetooth transreceiver 50, a PIC microcontroller 51, a vibrator motor circuit driver 63 and vibrating motor actuator 54. The circuit is embedded into the pet jacket. This enables the pet to feel the touch sensation. Initially, touch data from Human Side System is sent via the Internet to Pet Side System. The computer on the Pet Side System sends the touch data to pet jacket 8 via Bluetooth. Touch data is processed to drive the vibrating motor 54 to reproduce the touch sensation. The haptic pet jacket 8 worn by the pet is designed to enable the pet to feel the touch sensation. High frequency vibrating motors 54 (or vibrotactile actuators) is used because vibration can relay information about phenomena like surface texture, slip, impact and puncture. The actuators are distributed at different places in the jacket, corresponding to the spots of the touch sensors inside the pet doll.

FIG. 9 describes a pet detection algorithm use on the Pet Side System to track the movement of the pet using a web camera. During the Background modeling phase 72, the camera obtains backyard images without the presence of the pet. During the Threshold Selection phase 73, the background is modeled statistically on a pixel by pixel basis to obtain brightness and chromatic values. In the Background reference image phase 74, the background image and the associated parameters are calculated over a number of static background frames. Threshold values used in background subtraction are chosen to obtain a desired detection rate. Non background pixels form the object being tracked.

FIG. 10 shows different program tasks for the Pet Side System. After connecting to the server, Backyard Client 75 executes three tasks simultaneously. In one task, it receives touch data 76 then sends the touch data to jacket 8 via Bluetooth 77. In another task, it executes the pet tracking algorithm as described in FIG. 9 78, performs background subtraction 79 and store tracking data to shared resource 80. The final task reads tracking data 81 from the shared resource and sends that data to Human Side System computer 82.

With reference to FIG. 11, the flowchart for the program running on the computer on Human Side System is shown. In the context of the system as a whole, the Human Side System computer 82 acts as a network client that obtains the tracking data from the Pet Side System computer via the Internet, converts the data from pixel coordinates to table coordinates and sends this data to the motor control module via serial port. By utilizing multi-threading, handshaking issue of serial communication with PIC is eliminated. The initialization stage involves setting up the serial port for RS232 communication 83, setting up the Human Side System Client for networking 84, receiving touch data from RS232 and sending touch data to Pet Side System Client via Internet 85, and waiting to receive tracking data from Pet Side System Client and sending tracking data to microcontroller via RS232.

FIG. 12A shows a general structure of the microcontroller program. We use four microcontrollers in the Human Side System. Three microcontrollers are used to control motor movement on the three axes, while the fourth microcontroller is used to detect touch data and send it back to the computer. The program starts by configuring the respective ports to be used later on in the program. After configuring the ports, the program proceeds to setup Timer 0 and to enable Timer 0 interrupt. During initialization phase 87, the microcontrollers automatically move the pet doll to the center of the positioning table, facing a fixed direction. The tracking phase is done fully by software and does not involve the checking of the photoreflector sensors.

FIG. 12B shows a detailed program flowchart for the Initialization phase 87. The initialization phase involves checking if the pet doll has been moved to the center of the table. Once it has detected that all the other axes are initialized i.e. the pet doll has moved to the center of the table, it will enable the receive data interrupts and move to the main tracking phase. The program starts with the microcontroller continuously generating stepping pulses to stepper motor controller (L297) chip 88. The microcontroller stops sending stepping pulse when it has detected a signal from either the photoreflector or the index wheel depending on the axis of movement 89. The program then goes to the tracking phase 90. The microcontroller controlling the X axis is also used to keep track of whether the other axes have been initialized.

FIG. 12C shows a detailed program flowchart for the main tracking phase 90. Initially it checks for new data in receive buffer 91. If there is new data, the program obtains the newly received data and stores it in an array 92. It then checks for data validity 93 and disables the receive interrupt if data is valid 94. Valid data is decoded into X and Y coordinate 95. After that, Timer0 interrupt is enabled to rotate motor 96. At this stage, the receive interrupt is enabled to get new data 97. Finally the stepper motor is controlled to move the pet doll 98. This program will loop continuously to check if there is any data received that is stored in the buffer. Every one byte of data received is stored in a four bytes array. Every first byte will be checked and compared to see if it is the header byte. Once header byte is received, the rest of the three bytes that follow are stored in the subsequent array positions. Upon receiving four bytes of valid data, the receive data interrupt is disabled.

FIG. 13 shows the architecture of the system level design for the Human Side System. The system consists of a computer 140, a microcontroller to control X axis of the mechanical positioning table 141, a PIC to control the Y axis 142, a PIC to control the rotation (Z) axis 143, a PIC to process data from touch sensors 144, three stepper motors X, Y and Z respectively 145 and a wireless transceiver module 146. It operates in the following manner; the computer 140 receives tracking data, and converts this data from pixel coordinates into table coordinates, encodes this pair of X, Y data into four bytes and sends the data to PIC 141 via RS232 serial transmission. At the same time it receives touch data from PIC 144 and sends it to the PIC which controls the X axis. This PIC 141 functions as the main controller of the motor control board. It 141 synchronizes the initialization stage, signaling the other two PIC controlling Y 142 axis and Z 143 axis when the initialization stage is complete. PIC X 141 will perform the computation for the orientation from data received and send the result to both PIC controlling axis Y and axis Z via USART. The initialization stage position sensors are also connected to PIC X 141. Stepper motors X, Y, Z 145 are controlled by PIC X 141, PIC Y 142 and PIC Z 143 respectively by using stepping pulse signal. Touch data is processed by PIC for touch 144. The touch data is received wirelessly via a transceiver module 146 and then sent to computer 140 via RS232 serial port.

Although the description above contains many specificities, these should not be construed as limiting the scope of the invention but as merely providing illustrations of some of the presently preferred embodiments of this invention. For example, the form of the input and output devices are not restricted to a certain pet. Also, computer as mentioned in the description encompasses any home or portable computing device that has the ability to run software programs and connect to the Internet.

Thus the scope of the invention should be determined by the appended claims and their legal equivalents, rather than by the examples given.

What is claimed is:

1. A system for the user to interact with a pet in a remote area via an Internet connection. The said system consists of a Human Side System and a Pet Side System wherein the pet is at the Pet Side System end while the human user interacts with a pet doll that is placed on an XY mechanical positioning table that tracks the movement of the actual pet. The user's interaction with the pet doll in the Human Side System in the form of touch is sensed and sent to the Pet Side System which recreates the touch sensation in the haptic pet jacket. The movement of the pet in the Pet Side System is tracked by a web camera and is sent to the Human Side System where those motions are recreated by the said XY mechanical positioning table and software system.

2. The process described in claim 1 wherein the touch data is transferred from the Human Side System computer via the Internet to the Pet Side System computer.

3. The process described in claim 1 wherein the movements of the pet is captured by a camera and transferred from the Pet Side System computer to the Human Side System computer via the Internet.

4. Device recited in claim 1 wherein said XY mechanical positioning table consisting of two mechanical arms and three stepper motors to recreate pet movements on a two-dimensional platform, and an encoder module and code wheel to initialize the orientation of the pet doll at the start of the system.

5. Device recited in claim 1 wherein said pet doll has embedded touch sensors that captures human touch.

6. Circuit in the device recited in claim 5 wherein the touch sensory data are wirelessly transmitted to the Human Side System computer.

7. Device recited in claim 1 wherein said pet jacket recreates the touch sensation on the pet using vibrating actuators.

8. Circuit in the device recited in the claim 7 that receives touch sensory data wirelessly from the Pet Side System computer.

9. A circuit that is interfaced to said Human Side System computer and that is used to receive touch sensor details wirelessly from said pet doll and receives the pet coordinate details from the Pet Side System device recited in claim 5.

10. Software algorithm that details the tracking which is used in the computer of the Pet Side System recited in claim 1.

11. The subprograms in said algorithm recited in claim 10 detailing threshold selection, background reference image, background subtraction, pixel classification used to identify the coordinates and the orientation of the pet in the backyard system.

12. The algorithm used in the Human Side System computer that is used to receive the pet tracking data from the Pet Side System computer and to receive the touch data from said pet doll and send it to the Pet Side System via the Internet.

13. Microcontroller firmware algorithm used in the Human Side System recited in claim 7 that details the initialization phase where the control signals are issued to the stepper motors of the said XY mechanical positioning table and the tracking phase where the tracking details are received from the Human Side System computer and decoded to attain the coordinates and the orientation details of the pet.
